(19) United States
(12) Patent Application Publication
(10) Pub. No.: US 2014/0189991 A1
(43) Pub. Date: Jul. 10, 2014

(54) Milling machine having six (6) axis motion system

(71) Applicant: D4D Technologies, LLC, Richardson, TX (US)

(72) Inventors: Rod Duncan, Dallas, TX (US); Mark Quadling, Plano, TX (US); Henley Quadling, Dallas, TX (US); Chris Partee, Dallas, TX (US); Adam Tibbitts, Dallas, TX (US)

(73) Assignee: D4D Technologies, LLC, Richardson, TX (US)

(21) Appl. No.: 14/048,472

(22) Filed: Oct. 8, 2013

Related U.S. Application Data
(60) Provisional application No. 61/710,797, filed on Oct. 8, 2012.

(51) Int. Cl. A61C 13/00

(52) U.S. Cl. CPC A61C 13/0003; A61C 13/0006
USPC 29/56.5; 409/205; 409/131

(57) ABSTRACT

A milling machine for a dental item comprises a six (6) axis motion system. A workpiece is fixed in space. Each of a pair of opposed tool spindles operates in 3 DOF, with an x-axis (laterally, left or right) being along an axis of each working tool, a rotational (theta (θ)) axis (rotationally in or out), and a z-axis (up or down). On each respective side of the block, the x-axis rides on a θ-axis, and the θ-axis rides on the z-axis. Each z-axis supports a first carriage adapted to move up or down along the z-axis, and the first carriage supports a motor having a shaft. The shaft's rotational axis is the θ-axis. A second carriage is mounted on the shaft for rotation about the θ-axis. A spindle assembly is mounted on the second carriage for lateral (left or right) movement along the x-axis carried by the θ-axis.

### BACKGROUND

1. Technical Field

This disclosure relates to a milling machine that is used to mill a dental item (e.g., a crown, an implant, or the like) from a blank.

2. Background of the Related Art

One of the most common procedures for a dentist is the repair of a broken tooth. When a tooth is broken, a portion of the enamel comes off, exposing the dentin underneath. The dentin must be covered to prevent the dentin from becoming infected.

The dentist will grind a portion of the remaining enamel away to prepare the tooth for a crown. Once the grinding procedure is complete, a reduced stump remains and a mold of the stump is made with a quick setting mold material. Further a mold of the adjacent teeth and the opposing teeth are also made. Then a temporary crown in placed on the stump. The temporary crown has been partially customized to fit over the stump and to mesh with the opposing teeth. However, due to traditional time constraints, the temporary crown rarely feels as natural as the original tooth. Further, the temporary crown must be affixed to the stump with a temporary fixative.

With the mold as a guide, an outside laboratory will prepare a permanent crown. The permanent crown may be made of porcelain, gold, a ceramic material, or some other metal or substance. This process usually takes at least three weeks to complete. During this time, the patient must function with the temporary crown. Unfortunately, there is a risk that the temporary crown may loosen and be swallowed or otherwise lost by the patient. Even if it only loosens, bacteria can gain access to the dentin for a time and cause more serious dental health issues. Also, once the permanent crown is available for placement, the temporary crown must be removed. This requires the dentist to twist the temporary crown off the stump, exerting a significant torque to the roots. Even then, if the permanent crown is misshaped, then it may need to be removed again and remade.

It is known in the prior art to provide systems, methods and devices for improving the speed of producing a permanent crown for a patient using what have now become known as “chair-side” solutions. One such solution is available from D4D Technologies, LLC of Richardson, Texas. Relevant technologies are described in several patents including, without limitation, U.S. Pat. Nos. 7, 142,312, 7,184,150, 7,226,338, 7,270,592 and 7,497,817.

Several of these patents describe a milling machine for producing dental items from blanks using opposed spindles. U.S. Pat. No. 7,270,592 is representative. In this mill, the spindles that rotate the milling bits are located on a common rail, giving the device the ability to move the tools in the x-axis. Preferably, the spindles are not co-axially aligned in the x-axis, but rather there is an offset that is roughly equal to or greater than the diameter of one of the tools used. In operation, the dental blank is attached releasably to a mandrel. The mandrel is secured to a subassembly that allows motion in the y-axis and the z-axis. The milling machine includes a CPU and memory for storing the data on the contour of the crown or inlay.

While a milling machine such as described above provides satisfactory results, it is desired to reduce the overall form factor of the machine and to enhance its operation.

### BRIEF SUMMARY

According to this disclosure, a milling machine for a dental item comprises a six (6) axis motion system. A working piece (e.g., a dental item block) is fixed in space, and there is no feed axis required for the block. A pair of opposed spindles hold the working tools. Each spindle operates in three (3) degrees of freedom (3 DOF), with an x-axis (laterally, left or right) being along an axis of each working tool, a rotational (theta (θ)) axis (rotationally in or out), and a z-axis (up or down). On each respective side of the block, the x-axis sits (rides) on a θ-axis, and the θ-axis sits (rides) on the z-axis. Each z-axis supports a first carriage adapted to move up or down along the z-axis, and the first carriage supports a motor having a shaft. The shaft's rotational axis is the θ-axis. A second carriage is mounted on the shaft for rotation about the θ-axis. A spindle assembly is mounted on the second carriage for lateral (left or right) movement along the x-axis carried by the θ-axis.

The foregoing has outlined some of the more pertinent features of the subject matter. These features should be construed to be merely illustrative.

### BRIEF DESCRIPTION OF THE DRAWINGS

The subject matter of this disclosure, as well as further objectives and advantages thereof, will best be understood by reference to the following detailed description of an illustrative embodiment when read in conjunction with the accompanying drawings, wherein:

FIG. 1 is a perspective view of a prior art milling machine;

FIG. 2 is perspective showing the carriage that controls the x-axis movement of the spindles in the prior art milling machine;

FIG. 3 is a top view of the x-axis carriage for an alternate embodiment of the prior art milling machine;

FIG. 4 is a view of a mill of this disclosure that includes a 6-axis motion system and two spindles;

FIG. 5 is another view of the mill of this disclosure; and

FIG. 6 is a perspective view of the mill of this disclosure with its external housing removed and the grind chamber being visible;

FIG. 7 is a front elevation view of the mill with the grind chamber omitted and illustrating the motion system, together with a tool changer mechanism in its stored position;

FIG. 8 is a perspective view of the motion system of the mill with the external housing and grind chamber omitted; and

FIG. 9 is a top view of the motion system of the mill with the external housing and grind chamber omitted and showing the tool changer mechanism in its working position.

### DETAILED DESCRIPTION

A milling machine typically is sized to fit on the countertop of a dentist office or in a lab. Its generally compact size however does not mean that the quality of end product is diminished. Instead, the milling machine is built robustly that it produces high quality crowns and inlays. Although not an aspect of this disclosure, typically an intra-oral digitizer is used to measure the dimensions of the prepared tooth, as well as the adjacent and opposed teeth. Software within the digitizer constructs an outer contour that meshes with the adjacent and opposing teeth. The design is approved by the dentist and then conveyed to the milling machine.

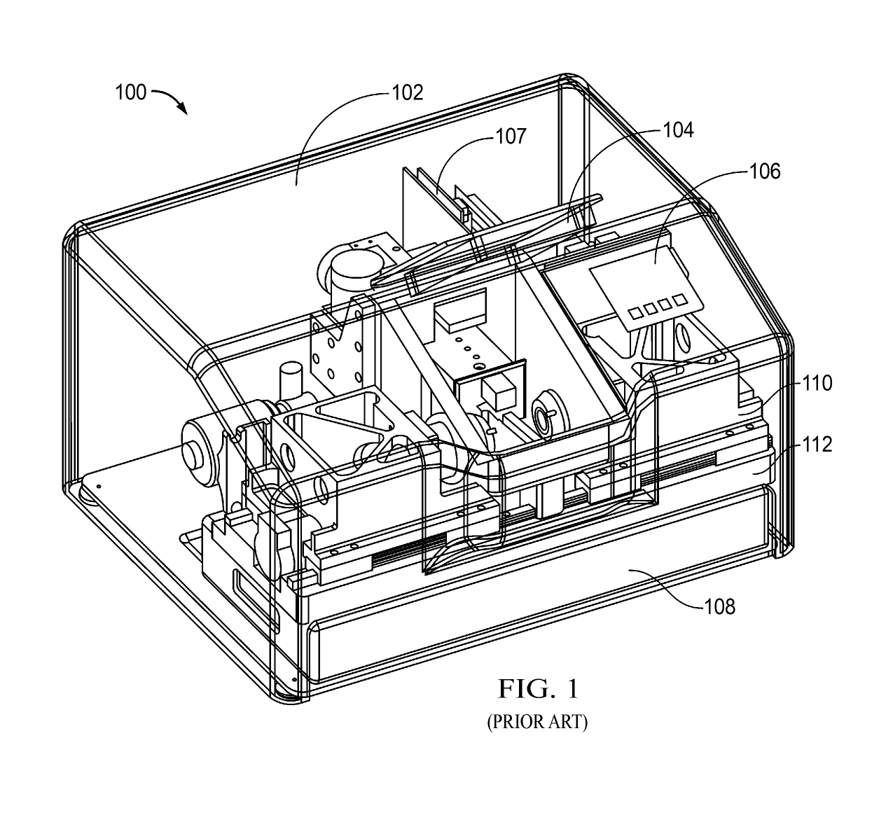

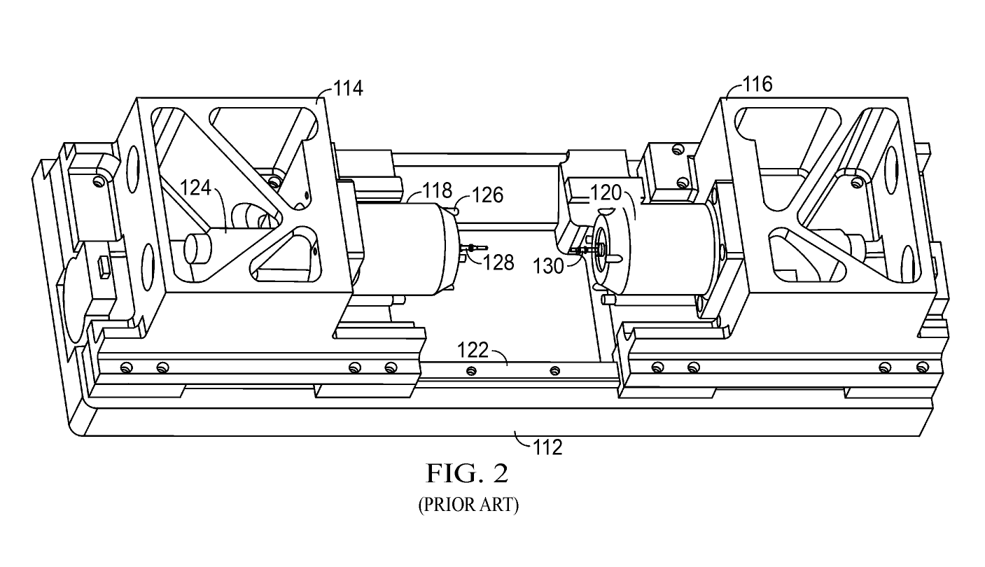

FIGS. 1 and 2 provide perspective views of a prior art milling machine 100, such as described in U.S. Pat. No. 7,226,338. The machine includes a cover 102 that protects the operator from the moving parts within. A blank 10 is held within a work area that is accessible through door 104. The x-axis carriage 110 is used to move the tools back and forth into engagement with the blank 10. The carriage 110 includes a first and second frame that both slide on rails on subframe 112. The subassembly 140 is used to control the y-axis and z-axis movement of the mandrel and blank. While the tools are manipulated in the x-axis, this is just an issue of reference. As described in that patent, the tools could be manipulated in the y-axis and the blank moved in the x-axis and z-axis. Alternatively, the tools could be manipulated in the z-axis and the blank manipulated in the x-axis and y-axis. A reservoir is also located at the bottom of the machine 100. The CPU, memory and other electronics are located in compartment 107. These can be controlled, or activity displayed on display 106.

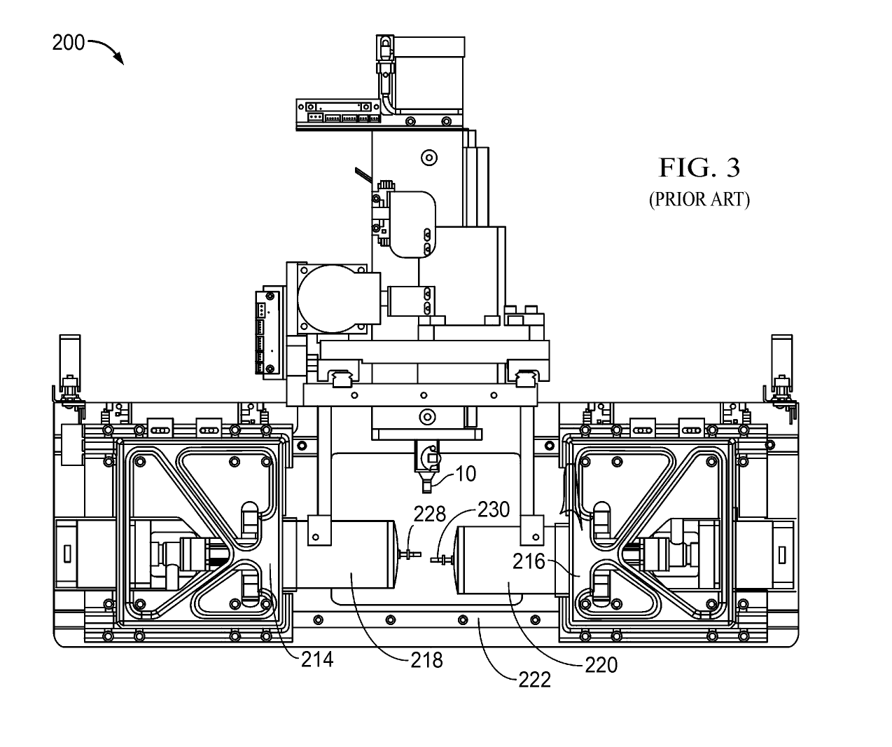

FIG. 2 is an isolated view of the x-axis carriage 110 in the prior art milling machine. It includes a first frame 114 and a second frame 116. In one embodiment, these frames are formed from a single block of metal, having no seems to decrease their stiffness. A first and second spindle 118, 120 are coupled to these frames 114, 116. The frames 114, 116 move on a single pair of rails 122 to ensure absolute alignment. Each frame is coupled to a first and second spindle, wherein each spindle has a central axis. In this embodiment, the central axis of each spindle is aligned. In the alternative, and as discussed below in reference to FIG. 3, the axis of each spindle can also be offset. Tools 128 and 130 are accepted into the spindles along this axis. The spindles rotate the tools so that a cutting surface on the tool can carve away material from the blank as desired. This machining process generates heat and carvings. A fluid stream emits from the spindle ports 126 as well to wash and cool the blank during milling. This effluent exits to a reservoir where particulate matter can settle. Motors 124 are used to supply the power to move the frames along the rails and to rotate the tools within the spindles.

FIG. 3 is a top view of the x-axis carriage for an alternate embodiment of the prior art milling machine 200. It includes a first frame 214 and a second frame 216. In one embodiment, these frames are formed from a single block of metal, having no seems to decrease their stiffness. A first and second spindle 218, 220 are coupled to these frames 214, 216. The frames 214, 216 move on a single pair of rails 222. Each frame is coupled to a first and second spindle, wherein each spindle has a central axis. In this embodiment, the central axis of each spindle are offset rather than aligned. In one embodiment, the offset can be roughly equal to or slightly greater than the diameter of a tool. Tools 228 and 230 are accepted into the spindles. The spindles rotate the tools so that a cutting surface on the tool can carve away material from the blank as desired. Of course, this process generates heat and carvings. A fluid stream emits from the spindle ports (not shown) as well to wash and cool the blank during milling. This effluent exits to a reservoir where particulate matter can settle. While the offset is shown in x-axis, it could also be in the y-axis.

Mill with 6-Axis Motion System

With the above as background, the milling machine of this disclosure is now described.

The mill grinds or cuts a dental restoration from an approved dental blank using a CAD-based dental model. This CAD model is created from the scanned data of a dental object and the tooth anatomy created by an operator using a computer-aided design device or system, such as the E4D Studio, available from D4D Technologies of Dallas, Texas.

Preferably, the mill of this disclosure is a fully-enclosed, single-unit table-top device. It includes a user-accessible grind-chamber with protective lid and an LCD with a touch-screen for a user interface.

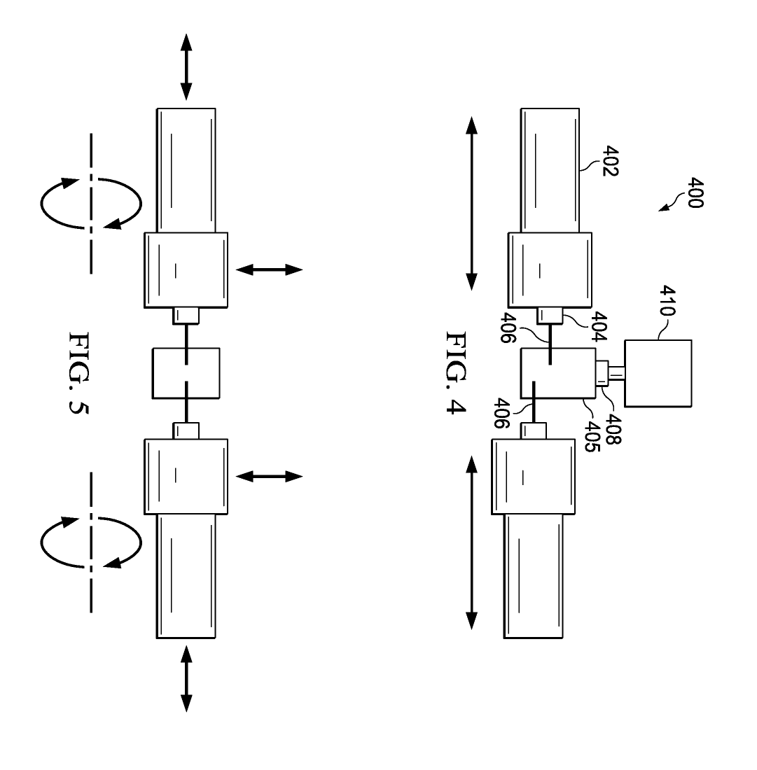

As will be described, preferably the mill includes a 6-axis motion system and two spindles as illustrated in FIGS. 4 and 5.

As illustrated in FIGS. 4-5, preferably the left and right halves of the machine are minor images of one another. Each spindle assembly 400 comprises an auto-chucking spindle/motor 402, a collet 404 that holds the tool, and the tool 406 itself. Preferably, diamond grit grinding tools are used for machining fully and partially sintered ceramic and composite materials. The collets are opened and closed pneumatically. As illustrated, each spindle assembly 400 moves linearly along the X-axis. This X-axis is mounted onto a rotational theta axis which rotates +/−45 degrees about the vertical on an axis that is parallel to the X axis. Both of these axes are translated vertically along the Z axis. Spindle offset can be held dynamically through software.

The block 405 from which the dental restoration is machined is held by a mandrel 408 that may be glued to the block and that is inserted into a mandrel holder 410 that preferably is a permanent part of the mill and is spatially-fixed. The mandrel holder preferably includes a quick-release mechanism to allow blocks to be easily inserted and removed.

In operation, a fluid is directed at the point where the tools touch the block to remove debris, to cool the tools, and to act as a machining lubricant. Particles in the fluid partially settle in a circulation tank and the fluid is re-circulated within the mill.

The mill preferably includes a tool-changer, which provides the ability to change tools under software control, without operator assistance. Because the tools are likely to have slightly different lengths and diameters, preferably the machine includes a means to detect the length of the tool in addition to a capability of measuring the critical characteristics of each tool as it is picked up from the tool changer or wear of the tools between subsequent jobs. A known mechanism may be used for this purpose.

In FIG. 4, the horizontal axis represents the x-axis; the theta axis rotates about an axis parallel to but below the x-axis by a radius equal to R. In FIG. 5, the vertical axis represents the z-axis and the horizontal axis represents the x-axis.

Preferably, the mill includes an embedded (on-board) computer that controls the mill's operation. Preferably, the computer provides a graphical user interface via an LCD and touch-screen. The embedded computer incorporates various software, such as a tool path generation program, a milling application for machine control, a graphical user interface (GUI), and a lower level motion controller application. Milling jobs are received from a dental item design application (e.g., E4D Design Center) via a wired or wireless network connection.

The mill operates in six (6) axes of motion, two (2) pairs of which are parallel to one another, namely, x-left/x-right and z-left/z-right. The other two axes provide a rotational positioning of the respective spindles and the tools carried thereby. As described and illustrated, there are two (2) opposing spindles. In a typical (but non-limiting) use scenario, one spindle (x-right) is used primarily for machining an occlusal side of a restoration, while the other spindle (x-left) is used primarily for machining a cavity side. Preferably, and as noted above, the mill includes a tool changer mechanism that allows automatic removal and replacement of tools. A known tool changer mechanism is described in U.S. Pat. No. 7,670,272, assigned to the assignee of this application. In the approach herein, the tool change mechanism is adapted to rotate approximately 90 degrees from its stored (vertical) position, to its working (horizontal) position. Once the tool change mechanism is activated and brought into its working position, the tool change may be accomplished by opening the collet on the spindle (using pneumatics), positioning the spindle (that will receive the new tool) in association with the tool being carried by the changer, and then driving the spindle into the appropriate position in which it can receive (capture) the new tool (and then move away). Once the tool change has been accomplished, the tool changer mechanism retracts out of the way.

Preferably, the mill's motion system is such that tool length can be determined finely, e.g., to an accuracy of 10 um. In operation, the tool length can be readily determined by bumping the spindle against the fixed mandrel and measuring the distance traveled. Preferably, the mill accepts dental blocks up to 90 mm×20 mm×40 mm (length, width/x-axis, and height/z-axis). As noted above, preferably a quick locking mandrel system allows for dual orientation of the mandrel/block assembly. A re-circulating coolant system (not shown) is provided for removing debris from the grinding/cutting process. Preferably, each spindle incorporates quick release coolant nozzles that converge at or near the tip of the cutting tool.

Preferably, the x-, z- and theta-axes are driven via closed-loop brushless servo motors. The motion control system supports 6-axis coordinated motion with velocity, acceleration, and jerk components specifiable, preferably per-axis, per-motion segment.

Preferably, each axis includes an encoder sufficient to provide micron-level positional resolution. Without limitation, preferably each spindle is capable of speeds of up to a given amount, such as 100,000 rpm.

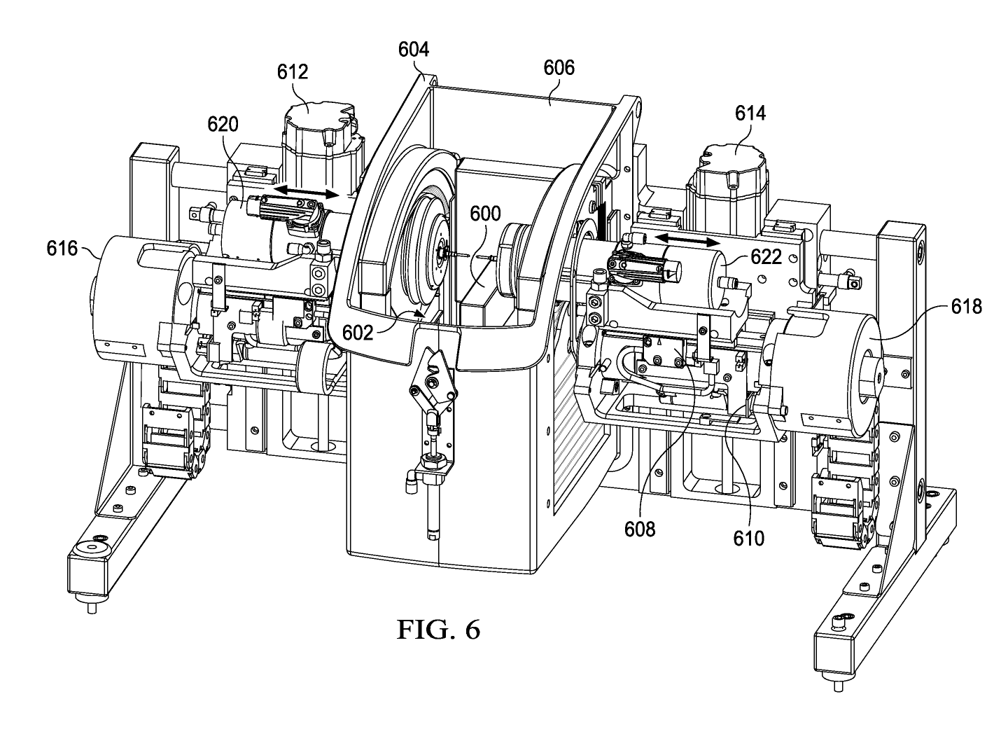

FIGS. 6-9 illustrate the motion system of the mill in further detail (with the external housing omitted). In particular, FIG. 6 is a perspective view of the mill with its external housing removed and a ceramic block 600 being positioned within a grind chamber 602 being visible. The grind chamber is closed by a hinged door 604 having a window 606 (e.g., plexiglass) through which the milling operation can be viewed. This view shows the left and right spindle assemblies in their working positions. An encoder 608 is positioned on each respective spindle assembly to provide position data to the controlling computer. Limit sensors 610 provides data to inform the motion system control program that an end-of-travel position has been reached.

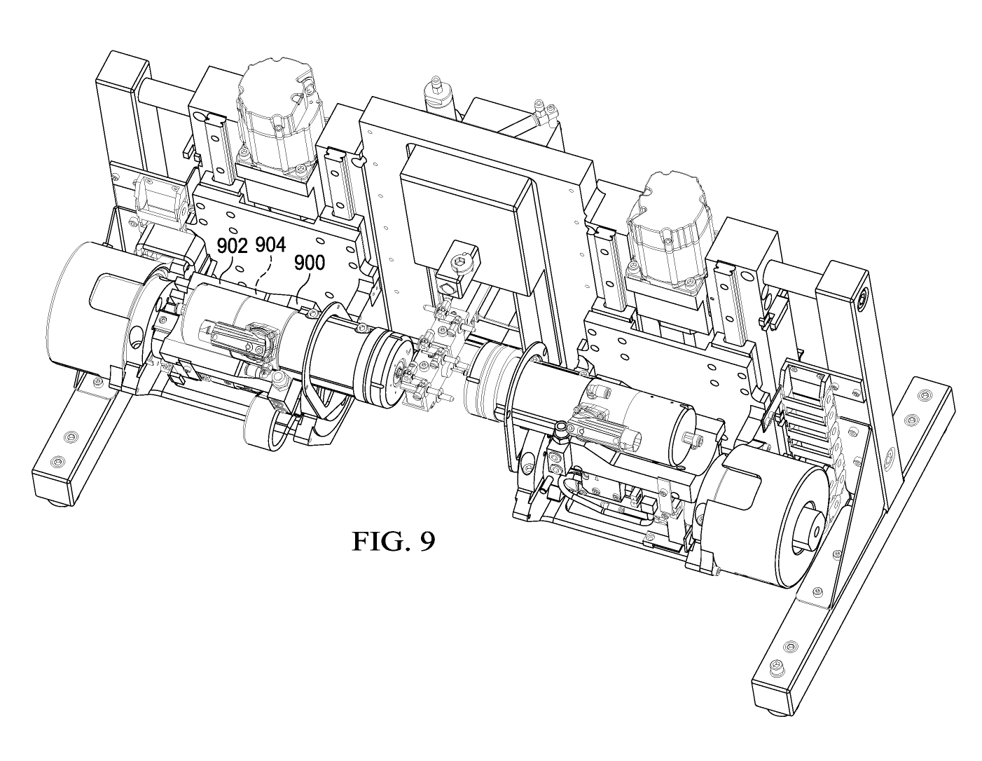

FIG. 6 illustrates the various the x-, z- and θ-motions, together with the motors that provide the respective motions along or about these axes. These include the z-left servo 612, the z-right servo 614, the θ-left servo 616, the θ-right servo 618, a spindle/motor (left) 620, and a spindle/motor right 622. Each respective spindle/motor secures and spins its associated grinding tool using for cutting the workpiece. Motion in the x-direction is accomplished by a linear servo motor that is not visible in FIG. 6, but that is shown in FIG. 9. As shown there, a linear servo motor 900 for the x-movement comprises a magnet 902, and a coil 904. The coil 904 extends vertically into a U-shaped cross-section of the magnet 902 and translates left and right. A similar configuration is provided on the opposed side of the mill.

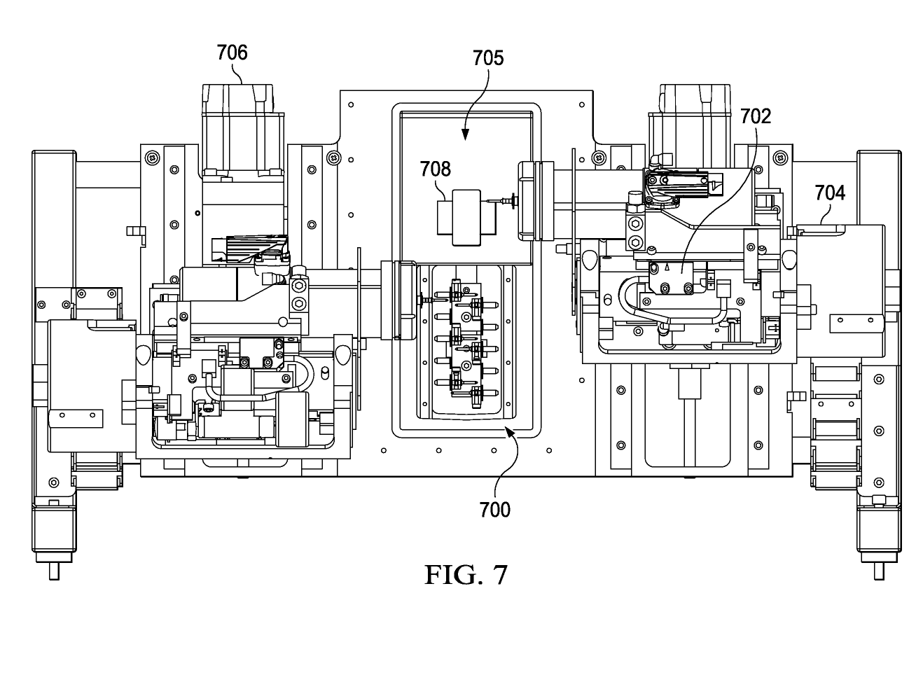

FIG. 7 is a front elevation view of the mill with the grind chamber omitted and illustrating the motion system, together with a tool changer mechanism 700 in its stored position. As noted above, preferably the motion system is used to lift tools out of their pockets in the tool changer mechanism when that mechanism is oriented as shown in FIG. 9. FIG. 7 also shows an x-linear encoder 702 used for x-motion, and a direct drive θ motor 704 used for θ axis motion (both for the right-side motion sub-system), and a servo/ball screw motor 706 used for z-axis motion (for the left-side motion sub-system). Further, this view also shows a quick release mandrel/block holder 708 in which the block to be milled is secured releasably. The motion system is mounted on a baseplate 705 that is positioned vertically with respect to the mill when supported on a support surface (not shown).

The terms “left” and “right,” or “up” and “down,” are used for discussion and illustration purposes, and they should not be taken as limiting the motion system described herein.

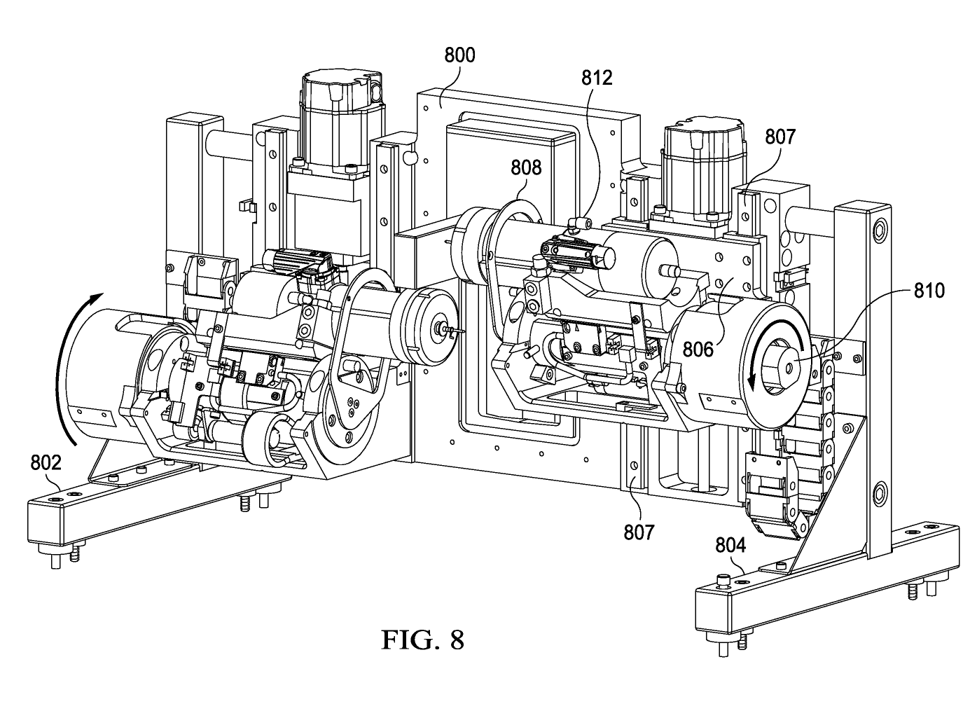

FIG. 8 is a perspective view of the motion system of the mill with the external housing and grind chamber omitted. As seen in the view, the motion system is supported on the vertical baseplate 800 supported between left and right frame supports 802 and 804. A first carriage 806 moves up and down on rails 807 to provide the z axis (up and down) motion. A second carriage 808 rotates on a θ axis shaft 810 and supports the x axis spindle assembly on each side of the mandrel. A mechanism 812 is provided to supply coolant to the grinding surface. In this view, the left side spindle assembly is shown in its full down position (on the z axis) with its associated theta axis rotated back, and the right side spindle assembly is shown in its full up position (on the z axis) with its associated theta axis rotated forward. As this view illustrates, on each respective side, an x axis sits (rides) on a theta axis, and that theta axis sits (rides) on the z axis. In other words, each z axis carriage caries theta motors and a theta shaft, which in turn carries the x carriage and associated x motion mechanism (linear motor, linear encoder, spindles, bearings, and so forth).

FIG. 9 is a top view of the motion system of the mill with the external housing and grind chamber omitted and showing the tool changer mechanism in its working position. In this example, the left spindle is shown picking up a tool from the tool changer, and the right spindle is shown probing a tool (to determine its position) via current feedback of the direct drive motor. These are just representative mechanisms for interacting with the tool changer.

In this mill configuration, the block being milled is basically fixed in space, and there is no feed axis (for the block). Each of the opposed spindles operates in three (3) degrees of freedom (3 DOF), with the x-axis being along the axis of the tool, a z-axis (up or down), and a rotational (theta) axis. The machining tools are each rotatable about the theta axis. Preferably, direct drive motors are used for the x and theta axis motion, and there are no ball screws or gears. The use of direct drive technology for the x and θ motions is highly advantageous, as it significantly enhances positional accuracy of the milling tools while at the same time substantially reduces or even eliminates backlash as the tools grind the block. The machine has a much smaller depth as compared to the prior art. As noted above, the machine may include a tool changer that rotates upward and into position.

While the above-described embodiment uses direct drive motors for the x and θ movements, the design may be implemented with other types of drive mechanisms, such as a conventional motor/screw for the x-axis movement, and gear or belt drive technologies for the θ movement. In addition, while servos are used for each axis in the described embodiment, the design may be implemented with stepper motors, or some combination of servos and steppers.

The phrase “dental item” is not intended to be limited to any particular type or object, and the term may refer to any type of dental-related object including, without limitation, crowns, implants, dental guides, among others. Further, the six (6) axis motion system of this mill may be implemented in other types of milling machines regardless of the nature of the workpiece itself.

There is no requirement that the control system (e.g., a computer) be on-board or part of the machine itself. The control system electronics and controls may be implemented in a separate computer system including a system located remotely from the mill itself. Control signaling may be provided over any wired or wireless connection, either locally or remotely (e.g., over a network-based connection).

There is no requirement that the motion system include opposed spindles. Depending on the nature of the workpiece and/or the desired milling operation, one-half of the above-described mill (i.e., only one spindle using the x-, z- and θ-based motion system) may be implemented as a standalone unit.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components or elements of the motion system have been described separately, one of ordinary skill will appreciate that some of the functions may be combined or shared. Further, while the disclosed subject matter has been described in the context of a method or process, the subject disclosure also relates to apparatus for performing the operations herein.

The milling machine of this disclosure is adapted to be controlled by a special purpose computer, or a general-purpose computing entity selectively activated or reconfigured by a stored computer program stored therein.

Having described our invention, what is claimed is as follows:

1. A milling machine, comprising:
structure that fixes a workpiece in a predetermined working position; and
opposed spindle assemblies each operating in three (3) degrees of freedom (3 DOF) relative to the workpiece, the degrees of freedom being a lateral x-axis, a rotational θ-axis, and a z-axis perpendicular to the x-axis, wherein the x-axis is positioned on the θ-axis, and the θ-axis is positioned on the z-axis.

2. The milling machine as described in claim 1, further including a grinding tool supported in each spindle assembly.

3. The milling machine as described in claim 2, further including a direct drive motor to provide lateral movement of a respective spindle assembly together with its associated grinding tool along the x-axis.

4. The milling machine as described in claim 2, further including a direct drive motor to provide rotational movement of a respective spindle assembly together with its associated grinding tool about the θ-axis.

5. The milling machine as described in claim 2, further including a servo motor to provide up or down movement of a respective spindle assembly together with its associated grinding tool along the z-axis.

6. The milling machine as described in claim 1 further including a tool changer mechanism.

7. The milling machine as described in claim 6 wherein the tool changer mechanism is adapted to be stored in a first position, and rotated from the first position to a second position adjacent the opposed spindle assemblies to facilitate a tool change operation.

8. The milling machine as described in claim 1 wherein the workpiece is a dental item.

9. A motion system for a milling machine, comprising:
a base positioned vertically;
a first carriage adapted to move up or down along a first axis parallel to a plane of the base, the first carriage supporting a motor having a shaft with a second axis;
a second carriage mounted on the shaft for rotation about the second axis; and
a spindle assembly mounted on the second carriage and further adapted for lateral movement along a third axis carried by the second axis, the third axis being perpendicular to the first axis.

10. A method of milling a workpiece, comprising:
fixing the workpiece in a predetermined working position; and
positioning opposed spindle assemblies each operating in three (3) degrees of freedom (3 DOF) relative to the workpiece, the degrees of freedom being a lateral x-axis, a rotational θ-axis, and a z-axis perpendicular to the x-axis, wherein the x-axis is positioned on the θ-axis, and the θ-axis is positioned on the z-axis;
grinding the workpiece using grinding tools carried by the opposed spindle assemblies.

11. The method as described in claim 10 wherein the workpiece is a dental item.
